(19) United States
(12) Patent Application Publication
(10) Pub. No.: US 2008/0136122 A1
(43) Pub. Date: Jun. 12, 2008

(54) Thermoplastic seal and method

(76) Inventor: Philippe Gambier, Houston, TX (US)

Correspondence Address: SCHLUMBERGER RESERVOIR COMPLETIONS, 14910 AIRLINE ROAD, ROSHARON, TX, 77583, US

(21) Appl. No.: 12/006,261

(22) Filed: Dec. 31, 2007

Related U.S. Application Data
(62) Division of application No. 10/675,559, filed on Sep. 30, 2003, now abandoned.

(51) Int. Cl. F16J 15/32

(52) U.S. Cl. 277/650

(57) ABSTRACT

A preload is applied to a thermoplastic seal to induce deformation of the seal. As the seal undergoes deformation (e.g., cold flow), it completes the seal. Thermoplastics such as PEEK, PEK, PPS, PEKEKK, and PET are examples of materials that may be used in the seal. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

This is a divisional of U.S. Ser. No. 10/675,559, filed Sep. 30, 2003, which is hereby incorporated by reference.

### BACKGROUND OF THE INVENTION

1. Field of Invention

The present invention relates to the field of seals. More specifically, the invention relates to a device and method for creating a seal using a thermoplastic component that is made to deform or cold flow.

2. Related Art

Many downhole applications require a reliable seal. For example, downhole control lines or cables (e.g., hydraulic, fiber optic, electric and combinations thereof) must frequently pass through or connect to downhole tools. Studies have proven that these connections often serve as the weak point in the system in terms of reliability. A failure of a seal in a control line connection may cause the complete system to fail.

Prior downhole seals include rubber or elastomeric seals, metal-to-metal seals, and seals that rely upon well fluid pressure to create the seal. Experience has shown that rubber or elastomeric seals are often unreliable, particularly at elevated temperatures. Metal-to-metal seals use a ferrule around a tube that is pushed into a housing to create the seal. While these seals are generally reliable, they rely upon carefully controlled metal surface finish. The metal surfaces may become easily scratched during installation (e.g., as the tubing and ferrule slides into the housing) or handling on a rig floor, which may result in a failure of the connection downhole. Additionally, the close tolerances required for a metal-to-metal seal are often difficult to achieve in relatively large parts.

Another type of downhole seals relies on fluid pressure to create the seal (e.g., chevron seals; see U.S. Pat. No. 6,406,028 as an example). These types of seals are commonly formed of elastomers or thermoplastics. While these seals are effective in certain applications, they are not suitable for all applications.

Thus, there is a continuing need for improvements in the area of downhole seals.

### SUMMARY

One aspect of the present invention provides a seal comprised of a thermoplastic material, such as PEEK, PEK, PPS, and the like. A preload applied to the seal causes the seal to deform or cold flow and form a seal.

### BRIEF DESCRIPTION OF THE DRAWINGS

The manner in which these objectives and other desirable characteristics can be obtained is explained in the following description and attached drawings in which:

FIG. 1 illustrates a well tool having a control line extending therethrough and a seal of the present invention.

FIGS. 2-10 also illustrate seals of the present invention.

FIG. 8 further illustrates a system for testing such a seal.

It is to be noted, however, that the appended drawings illustrate only typical embodiments of this invention and are therefore not to be considered limiting of its scope, for the invention may admit to other equally effective embodiments.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

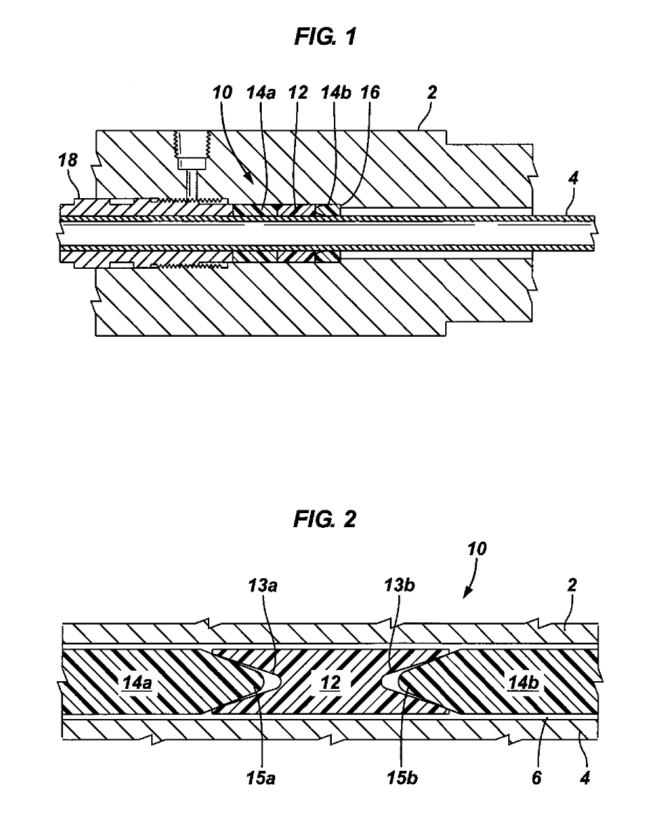

FIG. 1 illustrates a well tool 2 having a control line (or cable) 4 extending therethrough and a seal 10 of the present invention providing a fluidic seal therebetween. Although the seal 10 of the present invention is described herein as sealing between a well tool 2 (or housing) and a control line 4, the seal 10 may be used in other applications and other downhole applications that require a reliable seal.

The seal 10 is formed of an assembly of cooperating components. The seal 10 comprises a seal member 12 that is formed of a thermoplastic material. Ferrules 14a-b are provided on each side of the seal member 12. Ferrule 14b abuts a shoulder 16 provided in the well tool 2. A mandrel 18 (e.g., a screw) threadably mates with the well tool 2 and abuts ferrule 14a. As the mandrel 18 is screwed into the well tool, the mandrel 18 applies a force to ferrule 14a and squeezes ferrule 14a, seal member 12, and ferrule 14b between the mandrel 18 and the shoulder 16. Although primarily described herein as a stand-alone piece, the ferrule 14 may be integrated into a piece to be sealed.

FIG. 2 illustrates a seal 10 of the present invention. In this embodiment of the seal 10, the thermoplastic seal member 12 forms slots 13a-b (e.g., a v-slot) in each end. Each of the ferrules 14a-b have a protruding, tapered end 15a-b that abut the seal member 12 and extend into its respective slotted end 13a-b.

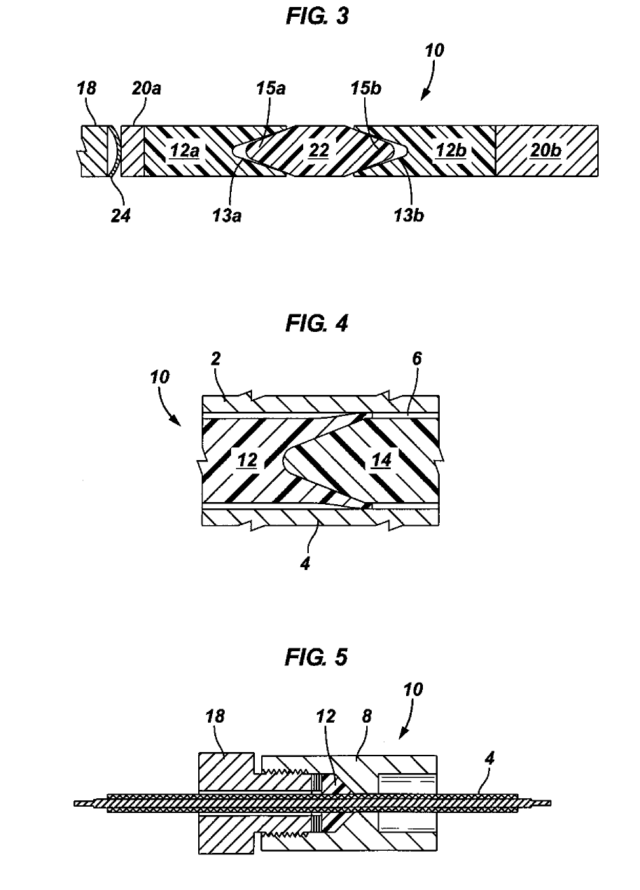

FIG. 3 illustrates another seal 10 of the present invention. This embodiment of the seal 10 has a thermoplastic seal member (12a-b) positioned on each side of an intermediate ferrule 22. The ferrule 22 has protruding, tapered ends 15a-b that abut and extend into slotted ends 13a-b of each of the seal members 12a-b. Washers 20a-b are placed on the respective opposite ends of the seal members 12a-b from the ferrule 22. The assembly shown in FIG. 3 has a spring 24, such as a Bellville washer, placed between the seal 10 and the mandrel 18.

With the seal 10 in place, a preload is applied thereto by, for example, tightening the mandrel 18 to squeeze the seal 10 as discussed above. The mandrel 18 is referred to generally herein along with other ways of applying a preload to the seal 10 as a “preload member.” When the thermoplastic seal member 12 is subjected to the preload, the end 13 of the seal member 12 will spread over the protruding, tapered end 15 of the ferrule 14 and fill the gap or annulus 6 between the parts to be sealed. The seal 10 of the present invention is subjected to a sufficient preload to induce a cold flow of the thermoplastic material into the gap between the ferrule 14 and the parts to create the seal. FIG. 4 illustrates the seal 10 after it has been subjected to a sufficient preload. As shown in FIG. 4, the seal member 12 deforms to fill the gap 6 and create the seal. If desired, the assembly may incorporate a spring 24 (FIG. 3) to maintain a force on the seal 10. However, once the preload is applied and the seal member 12 has undergone cold flow, the preload may relax or be removed in some applications without affecting the sealing capability of the seal 10.

The ferrule(s) 14 and washers 20 is formed of a relatively hard material suitable for the environment, such as a metal material. The seal member 12 is formed of a thermoplastic material that is capable of cold flow. Thermoplastic materials having a tensile modulus equal to or greater than 500,000 psi at room temperature are suitable for many downhole applications. Similarly, Thermoplastic materials having a flexural modulus that is equal to or greater than 500,000 psi at room temperature are suitable for many downhole applications. Particular thermoplastic materials that exhibit the desired cold flow characteristics for the seal 10 of the present invention are polyetheretherketone (PEEK), polypheneline sulfide (PPS), polyetherketone (PEK), polyetherketoneetherketoneketone (PEKEKK), polyethylene terephthalate (PET), and similar materials.

FIG. 5 shows a seal 10 for sealing around a control line (or cable) 4. The control line 4 extends through a housing 8. The seal has a thermoplastic seal member 12 inside the housing 8. The seal and seal member have tapered mating surfaces. Mandrel 18 threadably mates with the housing 8. When the mandrel 18 is screwed into the housing 8, the mandrel 18 applies a force to the seal member 12 causing it to deform (and cold flow) into the gap between the control line 4 and the housing 8. The deformed seal member 12 creates the seal between the control line 4 and the housing 8.

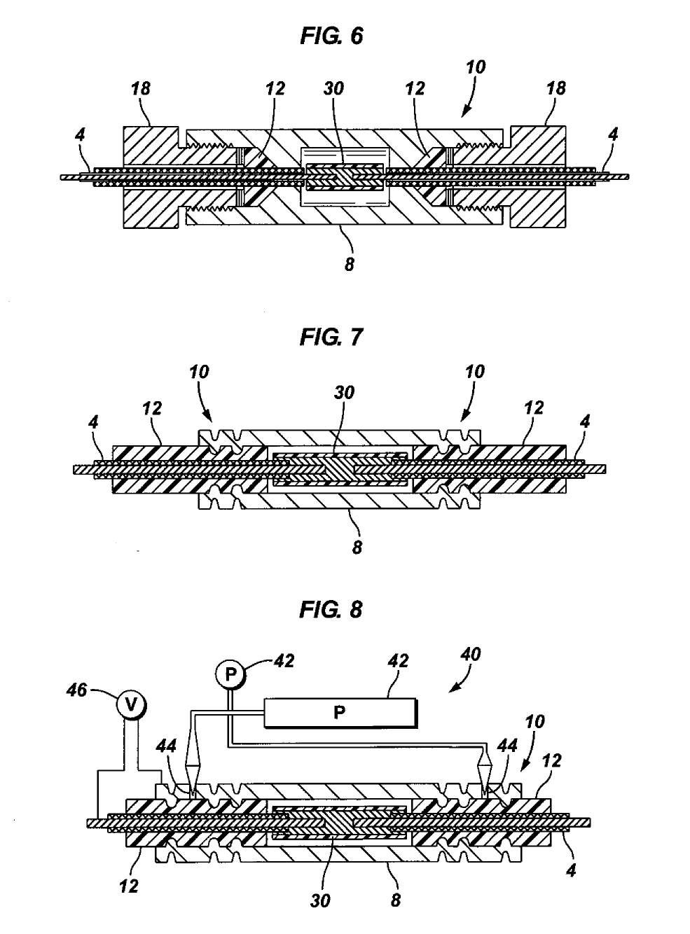

FIG. 6 illustrates a seal 10 having two seal members 12 and mandrels 18, one on each side of housing 8. Each of the seal members operates as described in connection with FIG. 5. The housing 8 defines a void within which two cables 4 are connected (connection 30) and, therefore, defines a connector housing.

FIG. 7 illustrates another type of seal 10 of the present invention. In the seal of FIG. 7, the seal member 12 is placed around the control line 4 within the housing 8. The housing 8 is then crimped to deform the housing 8 as well as the thermoplastic seal member 12. The deformation of the seal member 12 creates the seal between the housing 8 and the control line 4. Note the connection 30 of cables 4 formed between seals 10 of the assembly. Also note that the housing 8 and seal member 12 may be deformed at multiple spaced locations to create multiple seals.

FIG. 8 illustrates a system for testing a seal 10 of the present invention. The testing system 40 comprises pump(s) 42 communicating with ports 44 in the housing 8 between adjacent seals. By applying a pressurized fluid between the seals 10 and monitoring the pressure, leaks are detected as pressure drops. Also the testing system 40 may comprise a power source 46 used to apply a voltage to the control line 4 and the housing 8 to detect current leakage.

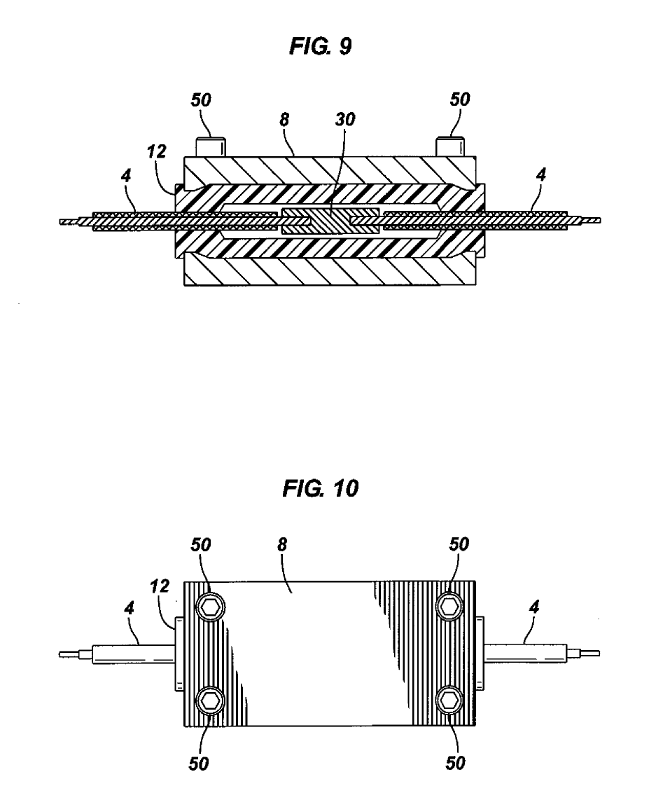

FIGS. 9 and 10 illustrate another embodiment for the seal 10 of the present invention. In this embodiment the seal member 12 is placed over the control line 4 in housing 8. Then, a squeezing force is applied to the thermoplastic seal member 12 by tightening screws 50 in the housing 8 to clamp on the seal member 12. The clamp force applied by the housing 8 causes the seal member 12 to deform and create the desired seal around the cable(s) 4. Note the connection 30 in the housing 8.

In each of the above seals 10, the seal member 12 is subjected to a preload force (e.g., by squeezing, crimping, clamping, etc.) that causes the seal member 12 to deform and create a seal.

Although only a few exemplary embodiments of this invention have been described in detail above, those skilled in the art will readily appreciate that many modifications are possible in the exemplary embodiments without materially departing from the novel teachings and advantages of this invention. For example, although discussed primarily in connection with a control line and a well tool, the seal 10 may be used with other downhole tools and in other applications. Similarly, the shapes of the seal member 12 and the ferrules 14 (e.g., the slots 13 and protruding, tapered ends 15) may be replaced with other features, or omitted depending upon the application. For example, the ends of one or both pieces may be flat or have a small chamfer, etc. depending upon the particular application, materials, preload, and other factors. Additionally, the seal member 12 and other components may have other shapes and features. Further, the seal member 12 may formed integrally with other components or applied to components in various manners. Accordingly, all such modifications are intended to be included within the scope of this invention as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. An apparatus comprising:
a cable having an outer surface; and
a seal assembly, comprising:
a thermoplastic seal, wherein the thermoplastic seal has a slot formed in an end thereof;
a preload member adapted to apply a force to and induce cold flow of the thermoplastic seal to seal against the outer surface of the cable.

2. The apparatus of claim 1, wherein the seal assembly further comprises a ferrule abutting an end of the thermoplastic seal.

3. The apparatus of claim 2, wherein the ferrule is formed of a metal material.

4. The apparatus of claim 1, wherein the seal assembly further comprises a ferrule having a protruding, tapered end engaged in the slot of the thermoplastic seal.

5. The apparatus of claim 1, wherein the preload member is a threaded mandrel.

6. The apparatus of claim 1, wherein the seal assembly further comprises a spring adapted to maintain a force on the thermoplastic seal.

7. The apparatus of claim 1, wherein the thermoplastic seal has a tensile modulus equal to or greater than 500,000 psi at room temperature.

8. The apparatus of claim 1, wherein the thermoplastic seal has a flexural modulus equal to or greater than 500,000 psi at room temperature.

9. The apparatus of claim 1, wherein the thermoplastic seal comprises PEEK.

10. The apparatus of claim 1, wherein the thermoplastic seal comprises PEK.

11. The apparatus of claim 1, wherein the thermoplastic seal comprises PPS.

12. The apparatus of claim 1, wherein the thermoplastic seal comprises PEKEKK.

13. The apparatus of claim 1, wherein the thermoplastic seal comprises PET.

14. A method for sealing, comprising:
providing a control line having an outer surface, the control line comprising at least one of a hydraulic line, fiber optic line, and electrical line;
providing a seal having a component formed of a thermoplastic, wherein the seal has a slot formed in an end of the seal;
inducing cold flow deformation of the component to create a fluidic seal against the outer surface of the control line, wherein the cold flow deformation is induced by engaging a tapered end of a ferrule in the slot of the seal.

15. The method of claim 15, further comprising applying a preload to the seal to induce the deformation.

16. The method of claim 15, wherein the deformation is caused by crimping.

17. The method of claim 15, wherein the deformation is caused by clamping.

18. The method of claim 16, further comprising maintaining the preload on the seal.

19. An apparatus comprising:
a control line having an outer surface, the control line comprising at least one of a fiber optic line and electrical line; and
a seal, comprising:
a ferrule; and
an adjacent seal member deformed by cold flow about at least a portion of the ferrule to seal against the outer surface of the control line, wherein the seal member has a slot in an end of the seal member, and wherein the ferrule has a tapered end to extend into the slot.

20. The apparatus of claim 28, wherein the seal comprises a thermoplastic component.
